(19) United States
(12) Patent Application Publication
(10) Pub. No.: US 2024/0239009 A1
(43) Pub. Date: Jul. 18, 2024

(54) METHOD FOR COATING AT LEAST ONE PRINTING MEDIUM WITH A LIQUID FLUID

(71) Applicant: Durst Group AG, Brixen (IT)

(72) Inventors: Stefan WALDNER, Mals (IT); Dennis OBERHUBER, Vahrn (IT); Clemens PORNBACHER, Sand in Taufers (IT); Oliver UNGERER, Kurtatsch an der Weinstrasse (IT)

(21) Appl. No.: 18/567,998

(22) PCT Filed: Jun. 20, 2022
(86) PCT No.: PCT/EP2022/025284

§ 371 Date: Dec. 7, 2023

(30) Foreign Application Priority Data
Jul. 15, 2021 (IT) 102021000018653

(51) Int. Cl. B28B 11/04; B05B 1/20; B05B 9/04

(52) U.S. Cl. CPC B28B 11/048; B05B 1/20; B05B 9/0423

(57) ABSTRACT

A method for coating at least one printing medium, in particular a ceramic printing medium, including the steps of (a) providing at least one coating head with a fluid supply channel, a plurality of nozzles, each having a nozzle channel and an inflow opening, which form the connection of the respective nozzle channels to the fluid supply channel, wherein the respective nozzles are arranged in a stationary manner on a side wall of the fluid supply channel; (b) filling the fluid supply channel with liquid fluid; (c) transporting the at least one printing medium along a transport direction; (d) applying a respective overpressure relative to the atmospheric pressure to the liquid fluid, at least in the area of each inflow opening of the nozzles, at least during the time intervals in which the at least one printing medium is to be coated in such a way that the liquid fluid is applied in the form of continuous columnar fluid jets to the at least one printing medium, wherein according to (e), during the time intervals in which no liquid fluid is to be dispensed from the nozzles, a respective negative pressure relative to the atmospheric pressure is applied to the liquid fluid at least in the area of each inflow opening of the nozzles, as a result of which an outflow of liquid fluid from the nozzle channels, even without the participation of the respective closing bodies assigned to the nozzles, is prevented in step e) and made possible in step (d).

The present invention relates to a method for coating at least one printing medium, comprising the step of providing at least one coating head with a fluid supply channel, a plurality of nozzles, each having a nozzle channel and an inflow opening which form the connection of the respective nozzle channels to the fluid supply channel, wherein the respective nozzles are arranged in a stationary manner on a side wall of the fluid supply channel; the step of filling the fluid supply channel with liquid fluid; the step of transporting the at least one printing medium along a transport direction and the step of applying a respective overpressure relative to the atmospheric pressure to the liquid fluid, at least in the area of each inflow opening of the nozzles, at least during the time intervals in which the at least one printing medium is to be coated in such a way that the liquid fluid is applied in the form of continuous columnar fluid jets to the at least one printing medium.

Methods for coating printing media are typically used to provide printing media as evenly as possible with at least one coating that is able to serve certain functional and/or decorative purposes and is intended to improve the surface properties of the printing media. Non-contact coating methods are preferably used when work is to be carried out at relatively high coating speeds, and are most preferably used when a relief-like decor provided on the surface of a printing medium, in particular a ceramic printing medium, is to be coated.

In the case of non-contact application methods, it is of great importance not only to dispense a liquid fluid as evenly as possible over a specific dispensing width of a coating system, but also to apply the liquid fluid as evenly as possible over a specific application width of a printing medium to be covered.

When coating ceramic printing media, non-contact methods which usually use a glaze suspension are used to refine their surfaces.

A method for coating ceramic surfaces of tiles that has been known for several decades, the so-called bell process, includes the step of providing a bell-shaped application system with a bell neck and a bell edge as well as the step of applying a glaze suspension via the bell neck by starting from the bell neck towards the bell edge and pouring it then via the latter in the form of a curtain onto the printing media running underneath in a transport direction. Although in principle it is possible to dispense the glaze evenly from the edge of the bell, this method has the problem that, due to the semicircular glaze curtain in combination with the relative movement between the glaze curtain and the printing medium, a greater quantity is applied to the surfaces of the printing media via the edge regions of the curtain than via the middle area of the curtain. Since the tiles in this process usually have a temperature of more than 40° C., the coating dries quickly, so that only shell-shaped, curved layer thicknesses can be achieved.

The currently most common coating method in the ceramics industry includes the step of applying a glaze suspension to ceramic surfaces by sputtering it, i.e. by distributing it in fine droplets, using one or more atomizing nozzles in the direction of the respective printing media. In a first embodiment of this method, the suspension is applied by periodically moving the one or more nozzles back and forth, if necessary offset relative to one another, along predetermined paths and spray patterns. In a second embodiment of this method, however, one or more stationary fluid atomizing nozzles are provided in order to apply the glaze suspension to the surface of the respective printing media, wherein glaze strips lying directly next to one another are formed. The aforementioned devices and methods are distributed, for example, either by Airless Italia S.R.L. under the name “airless” or by the company Airpower Group S.R.L under the name “slim cover”.

Fluid atomizing processes are advantageous over the bell process because, compared to the latter, they can apply significantly less glaze suspension, thereby saving costs. However, they also have the disadvantage that a highly homogeneous application of the suspension to the surface is not possible. This is due to the partially overlapping glaze strips produced by the spray patterns—especially on relatively wide formats of a ceramic printing medium—and/or the glaze strips arranged directly next to one another, in which it is practically impossible to achieve homogeneous transitions between the respective glaze strips. This is due to the spray patterns of the individual nozzles which cannot produce homogeneous glaze strips. Another disadvantage is the high loss of material that is associated with the necessary suction of the spray mist formed over the printing media, which would otherwise lead to greater inhomogeneity of the application in addition to polluting the environment.

What all of the above-mentioned processes have in common is that the application of the glaze suspension results in a surface coating having more or less distinct structural banding effects on the respective printing media.

Banding effects are known to be visible impairments in the quality of a coating and are characterized by the fact that, in a coating applied to a surface, abrupt or continuous transitions of attributes, such as gloss and/or color and/or structure (height), become visible or unpleasantly noticeable where transitions of this type are not desired but occur due to the process.

Furthermore, in the prior art, coating systems with an elongated slit or an elongated tear-off edge, each usually having a width of at least 50 cm, are used for coating printing media with a liquid fluid in the form of a curtain that falls freely, i.e. only due to the force of the gravity. The methods carried out with these systems have the disadvantage that a highly uniform application of liquid fluid is not possible due to the mechanical inadequacies inherent in an elongated slit or an elongated tear-off edge. This occurs, for example, when the printing media to be coated have a relatively high temperature, so that the applied coating dries before the height of the liquid fluid is compensated for, if this would have been possible at a lower temperature.

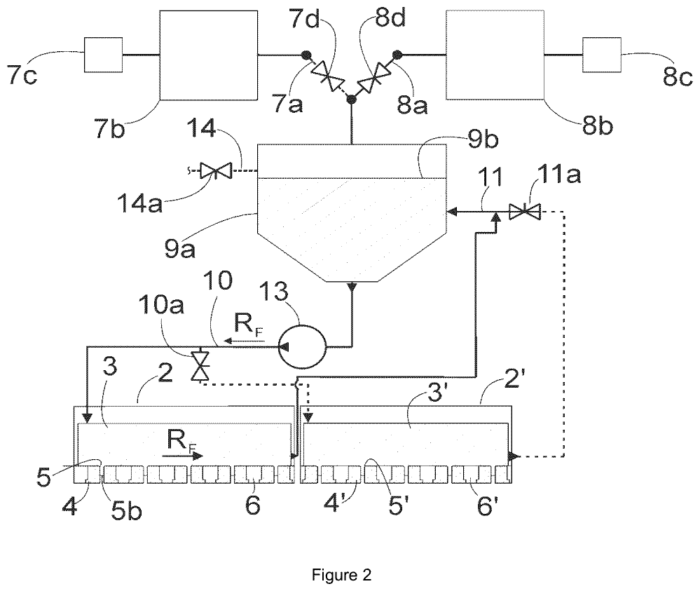

EP1252937A1, for example, discloses such a coating system in FIG. 2 and a corresponding method in which, in a first step, a liquid coating composition is pumped into a reservoir located above a print head for coating, from where, in a second step, solely due to the gravitational force acting on the coating composition, it flows downwards into a head part and then, in the form of a freely falling curtain-like film that is to be applied to the respective printing media, through the slit. This process uses the same principle as the bell process, with the difference that it works with an open fluid circuit in which the liquid coating composition that has not been applied to the respective printing media is fed back into the fluid circuit.

A novel method for completely coating ceramic surfaces includes the step of applying a glaze suspension using a “drop-on-demand” (DOD) inkjet printing process, in which the glaze is dispensed in the form of drops from a custom-made print head of an inkjet printing system. The systems that enable such processes are suitable for solving the above-mentioned disadvantages of unevenly dispensing and applying the glaze suspension to the printing medium. However, they consist of many parts and are complicated in structure, so that the purchase and especially the maintenance is and will be disproportionately expensive for the customer. In fact, systems and processes that work with DOD are, by their nature, actually designed for the purpose of printing not full surfaces, but rather an infinite variety of patterns and thus only partial areas of printing media.

In an alternative method for completely coating ceramic printing media the glaze suspension is applied by means of a print head with a row of nozzles, each of which is assigned an electronically controllable closing body for opening and closing them, and which method is designed to apply several glaze strips to the ceramic surface in such a way that the glaze suspension is applied to the surface in the form of several glaze threads that are essentially continuous. When this print head is in operation, an overpressure is always applied to the ink in the print head, and, in order to dispense the suspension, the closing bodies are moved from a shut-off position in which each of them closes the nozzle assigned to it in a fluid-tight manner to an open position and remain in this position to dispense the glaze with overpressure from the nozzles in the form of a substantially continuous glaze thread. Such methods work according to the principle of closing and opening while simultaneously maintaining an overpressure in the ink supply channel, i.e. both when the closing body is in the shut-off position and when it is in the open position. The reason for the glaze flowing out of the respective nozzles is the overpressure that is constantly present in the ink channel in combination with the closing bodies moving from a shut-off position to an open position and remaining in the open position so that the valve body passively participates in dispensing the glaze.

The use of this method also solves the above-mentioned problems of uneven application of the glaze suspension. However, the print heads used in this method usually comprise even more parts and have a more complex structure than a DOD print head, so that the purchase and especially the maintenance is and will be disproportionately more expensive for the customer. With these methods working according to the principle of closing and opening, there is also the problem that when the closing body changes direction in order to carry out opening and closing operations, periodic collisions with at least the nozzle occur which lead to material fatigue sooner or later and ultimately to material failure of the colliding components of the respective valves.

If a glaze suspension is to be applied to the respective printing media in these methods, then deposits and accumulations of the solid particles occur on the valve seat, i.e. in the area of the inflow opening of the nozzle channel of the respective nozzles. If it is dispensed again after a while during which no suspension was dispensed, it is not uncommon for nozzles to become at least partially clogged by the accumulated particles and, as a result, either strips occur on the printing media running in a transport direction, or the affected nozzles fail completely. In addition, particles of the glaze suspension flowing between the closing body and the valve seat of the respective nozzle have a negative effect in that the sealing step can no longer be carried out appropriately so that suspension is still dispensed via the nozzles in the actual sealing step, even if in a smaller amount.

There is therefore a need to specify a simple method for coating at least one printing medium as evenly as possible, which can work with different coating systems, in particular with systems of a simple design, and can therefore be used flexibly and which makes it possible to produce coatings in an economical manner, in particular with coating systems of a simple design.

The object of the present invention is therefore to provide a simple method for coating at least one printing medium as evenly as possible, which can work with different coating systems, in particular with systems of a simple design, and can therefore be used flexibly, and which makes it possible to produce coatings in an economical manner, in particular with coating systems of a simple design.

According to the invention the object is achieved with a method of the type mentioned above by applying a respective negative pressure relative to the atmospheric pressure to the liquid fluid, at least in the area of each inflow opening of the nozzles, during the time intervals in which no liquid fluid is to be dispensed from the nozzles.

The subclaims relate to further advantageous and, if necessary, additional inventive embodiments.

Accordingly, the method according to the invention is a method for coating at least one printing medium, comprising the steps of:
a) providing at least one coating head with a fluid supply channel, a plurality of nozzles, each having a nozzle channel and an inflow opening which form the connection of the respective nozzle channels to the fluid supply channel, wherein the respective nozzles are arranged in a stationary manner on a side wall of the fluid supply channel;
b) filling the fluid supply channel with liquid fluid;
c) transporting the at least one printing medium along a transport direction;
d) applying a respective overpressure relative to the atmospheric pressure to the liquid fluid, at least in the area of each inflow opening of the nozzles, at least during the time intervals in which the at least one printing medium is to be coated in such a way that the liquid fluid is applied in the form of continuous columnar fluid jets to the at least one printing medium.

According to the invention, in step e), a respective negative pressure relative to the atmospheric pressure is applied to the liquid fluid, at least in the area of each inflow opening of the nozzles, during the time intervals in which no liquid fluid is to be dispensed from the nozzles. As a consequence, an outflow of liquid fluid from the nozzle channels, even without or without the participation of the respective closing bodies assigned to the nozzles, is prevented in step e) and made possible in step d).

According to a preferred embodiment of the method according to the invention, a fluid circuit system is provided for supplying the at least one coating head with liquid fluid, comprising the at least one coating head. During operation this system forms a fluid circuit that is closed outwards to the atmosphere except for the nozzles of the at least one coating head and through which liquid fluid is pumped, preferably permanently, in a flow direction R_{F}.

This further development offers the advantage that contamination of the liquid fluid by dusty ambient air and a change in the composition of the liquid fluid by evaporation into the atmosphere are avoided. In addition, this development has the advantage that the risk of the liquid fluid drying out in the nozzle channels and/or at the nozzle openings can be drastically reduced or even prevented, thereby preventing partially or completely clogged nozzles or nozzles radiating at an angle.

The liquid fluid can also be pumped temporarily in a second flow direction opposite to the mentioned flow direction R_{F}, in order to enable, if necessary, the entrainment of particles of a suspension which are stuck at certain points in the circuit and which could not be entrained by pumping the liquid fluid in the first flow direction R_{F}.

In step e), the fluid pressure is to be adjusted in combination with the capillary pressure in such a way that no air is sucked into the fluid supply channel through the respective nozzle channels and that no liquid fluid flows unintentionally out of the nozzle channels. By definition, the fluid pressure is the sum of the circulation pressure and the meniscus negative pressure.

The liquid fluid can be pumped, preferably permanently, through the fluid circuit system by means of a pump, preferably a hose pump or a centrifugal pump. The centrifugal pump can be, for example, a circulation pump.

This further development has the advantage that, if at least one coating head is filled with a suspension as a liquid fluid, sedimentation of the particles of the suspension is also prevented in the area of the inflow opening of the respective nozzles. As a consequence, the risk of the particles agglomerating with one another and/or the risk of the respective nozzles becoming clogged by the particles is effectively reduced or even prevented.

According to a further preferred embodiment of the method according to the invention, the overpressure is applied to the liquid fluid using a first means for applying the overpressure to the liquid fluid and the negative pressure is applied to the liquid fluid using a second means for applying the negative pressure to the liquid fluid, wherein a transition from step e) to step d) takes place by opening a first operative fluid connection between the fluid supply channel and the first means and closing a second operative fluid connection between the fluid supply channel and the second means, and during step d) the first operative fluid connection remains open and the second operative fluid connection remains closed, wherein a transition from step d) to step e) takes place by closing the first operative fluid connection between the fluid supply channel and the first means and opening the second operative fluid connection between the fluid supply channel and the second means and during step e) the first operative fluid connection remains closed and the second operative fluid connection remains open.

This further development has the advantage that a quick change between the different pressure conditions in the respective area of the inflow openings of the nozzles is made possible. The amount of fluid that should not be applied to the at least one printing medium can thus be reduced.

The transitions from step d) to step e) and from step e) to step d) preferably take place abruptly and in particular simultaneously by closing abruptly, for example, in the first-mentioned transition, the first operative fluid connection by means of a first valve provided in the first operative fluid connection and by opening abruptly the second operative fluid connection by means of a second valve provided in the second operative fluid connection, wherein, during the second transition, the first valve is opened abruptly and the second valve is closed abruptly. As a consequence, the desired pressure conditions can be set even more quickly in the respective area of the inflow openings of the nozzles. Therefore, the amount of liquid fluid that should not be applied to the at least one printing medium can be further reduced.

Furthermore, it is possible to apply the overpressure to the liquid fluid using a gas overpressure reservoir of the first means, while the overpressure prevailing in the gas overpressure reservoir relative to the atmospheric pressure is controlled, preferably automatically, by means of a compressor of the first means and wherein the negative pressure is applied to the liquid fluid using a gas negative pressure reservoir of the second means, while the negative pressure prevailing in the gas negative pressure reservoir relative to the atmospheric pressure is controlled, preferably automatically, by means of a vacuum pump of the second means.

This development has the advantage that the setting of the pressure in the area of each inflow opening of the nozzles can be reduced even further in time. As a consequence, the amount of fluid that should not be applied to the at least one printing medium can be further reduced.

In a preferred embodiment of the method according to the invention, a respective overpressure relative to the atmospheric pressure is applied to the liquid fluid in the area of each inflow opening of the nozzles, such that in step d) per unit of time between 1/50 and ½, preferably between 1/15 and ⅓ of the volume of liquid fluid pumped through the fluid supply channel is dispensed through the nozzles, wherein the cross-sectional area of the fluid supply channel of the at least one coating head preferably is at least 1 cm², in particular at least 2 cm².

This development has the advantage that dispensing the fluid via the respective nozzles only causes a pressure loss over the length of the supply channel which is negligibly small compared to the pressure loss caused by friction, if the cross-sectional area of the fluid supply channel of the at least one coating head is at least 1 cm², in particular at least 2 cm², and the nozzles of the at least one coating head are provided as micronozzles.

According to a preferred embodiment of the method, the method further comprises the steps of:
providing the fluid circuit system with a fluid path that fluidically connects a fluid tank to the at least one coating head, wherein the fluid path fluidically connects the at least one coating head between a supply line and a return line, each of which is coupled to the fluid tank, so that liquid fluid is pumped, preferably permanently, from the fluid tank via the supply line through the coating head and back to the fluid tank via the return line,
wherein the filling of the fluid supply channel is carried out by filling the fluid tank with liquid fluid in such a way that a free liquid fluid surface is formed in the fluid tank with respect to a gaseous fluid, which is subjected to overpressure in step d) and negative pressure in step e),
wherein the fluid tank is provided with a sufficiently large capacity for the liquid fluid and with a free liquid fluid surface in a ratio of ≥10:1, preferably in a ratio of ≥20:1, to the cross-sectional area of the fluid supply channel.

In the context of the present description, a cross-sectional area of a fluid supply channel of a coating head is understood to mean that area in the fluid supply channel which is oriented transversely to the flow direction R_{F} and through which the liquid fluid flows.

This advantage of this further development is a very short setting time for the desired pressure in the area of each inflow opening of the nozzles both when changing from step e) to step d) and when changing from step d) to step e). The choice of such a ratio, for example, in the transition from step e) to step d) results in an acceptable volume flow that deviates from the predetermined target volume flow per nozzle and that causes an optically, i.e. with the naked eye, imperceptible change in application height compared to a predetermined target application height of the liquid fluid on the at least one printing medium.

If in a preferred embodiment of the method the smallest possible amount of liquid fluid or no liquid fluid at all is to be lost, the transition from step d) to step e) is initiated or carried out, for example, shortly before either a printing medium to be coated or the printing media to be coated in each case is or are transported from the effective range of the at least one coating head or the effective range of an effective row length of a coating head arrangement. As a result, however, an edge region of the same leading in the transport direction of the printing medium or the respective edge regions of the same leading in the transport direction of the printing media are each coated with slightly less liquid fluid, but a very small amount of liquid fluid or no amount at all is not applied to the respective printing media.

The first operative fluid connection can be provided as a direct first operative gas connection between the fluid circuit system and the first means, in particular as a direct first operative gas connection between the fluid tank and the first means, and/or the second operative fluid connection can be provided as a direct second operative gas connection between the fluid circuit system and the second means, in particular as a direct first operative gas connection between the fluid tank and the second means.

Furthermore, it is possible that the coating of liquid fluid applied to the at least one printing medium is concentrated and/or hardened, preferably immediately after application.

This means that immediately after concentrating and/or hardening, a further layer or a colored image can be applied to the concentrated and/or hardened layer without any loss of time.

In a preferred embodiment, the method according to the invention further comprises the step of providing a coating head arrangement with a plurality of coating heads, each coating head having at least one row of nozzles aligned at a certain angle to the transport direction of the at least one printing medium and the coating head arrangement having an effective row length, and wherein the coating head arrangement is designed such that the coating heads can be fluidically connected to the fluid path, in particular to the supply and return line, parallel to one another and/or in series to one another, and at least one coating head can be fluidically separated from the fluid circuit system, wherein, at least temporarily during the transport of the at least one printing medium through the effective range of the effective row length of the coating head arrangement in step d), preferably the entire time in step d), at least that coating head of the plurality of coating heads is fluidically separated, preferably automatically, from the fluid circuit system, in particular from the supply and return line, to which the at least one printing medium is not exposed.

For example, the at least one coating head of the fluid circuit system can be provided with a valve upstream of the coating head and a valve downstream of the coating head in the flow direction of the fluid, which are in particular automatically controlled.

This further development has the advantage that the amount of fluid that is not applied to the at least one printing medium or to the respective printing media can be further reduced, if the printing medium or the printing media each have a width that is smaller than the effective row length of the coating head arrangement.

In a particularly preferred embodiment of the method, the at least one coating head is provided in which the plurality of nozzles are arranged relative to one another and during step d) such a large amount of liquid is dispensed from the nozzle channels that the liquid fluid applied to the printing medium or to the respective printing media by means of immediately adjacent nozzles flows into one another during and/or immediately after the corresponding application to the at least one printing medium or to the respective printing media in order to form a flat coating that is homogeneous throughout the height over the entire width of the printing medium or the respective printing media.

This preferred solution has the advantage that the formation of a coating that is homogeneous in height over the entire application width is made possible, so that a coating with a substantially flat surface or flat surface is achieved.

According to a further preferred embodiment of the method according to the invention, the method further comprises the step of allocating respectively an actuator with an end face lying in the fluid supply channel to at least some nozzles of the at least one coating head. The purpose of this step is the respective regulation of the flow rate of the liquid fluid between the end face of the actuator and an end face of the nozzle surrounding the inflow opening, wherein, while the liquid fluid is being pumped from an inflow opening to an outflow opening, a pressure drop of the liquid fluid along the fluid supply channel in the flow direction R_{F} of the liquid fluid at the respective inflow openings of the nozzles is partially compensated for with respect to a selected nozzle by adjusting the respective distance between the respective end faces of the actuators and the respective end faces of the nozzles surrounding the inflow opening. This is done by reducing or increasing the corresponding distance, preferably once for a liquid test fluid, by moving the end face of the respective actuators towards the nozzle.

This preferred further development offers the advantage that differences in the volume flows of the fluid through the respective nozzle channels, which differences in the corresponding volume flows result from nozzles arranged along the fluid supply channel, are partially reduced. Due to the partial reduction of these differences in the volume flow, it is possible to achieve an even more homogeneous fluid coating on the respective printing media.

The setting of the respective distance between the respective end faces of the actuators and the respective end faces of the nozzles surrounding the inflow opening is typically carried out once after filling the fluid supply channel with a liquid test fluid, which is preferably a liquid fluid.

The longer a fluid supply channel, the greater the pressure drop downstream in the flow direction R_{F} of the fluid. In most cases, a pressure loss of up to a few millibars occurs in the flow direction R_{F}. The reduction of the distance between an end face of an actuator and an end face of a nozzle surrounding the inflow opening leads to a reduction in meniscus fluctuations of the liquid fluid in the nozzle channel and along the length of the lateral surface of the nozzle channel in case of pressure fluctuations in and along the fluid supply channel which occur, for example, during transitions from step d) to step e) and during the transition from step e) to step d). Consequently, the speed of the outflow of fluid and thus the volume flow of liquid fluid, i.e. the amount of liquid fluid to be dispensed per time, can be regulated. This also solves the problem of manufacturing tolerances in the nozzle channel diameter which lead to different volume flows. In order to achieve a homogeneous coating over a desired application width of the fluid on a printing medium it is of great importance to achieve a volume flow from each nozzle that is as identical as possible.

Due to the use of the system just described, a control valve is formed for the respective nozzles, which serves to regulate the flow by changing the distance between the end face of the actuator and the end face of the nozzle surrounding the inflow opening, and thus also the volume flow of the fluid through the nozzle channel.

There are different ways in which a person skilled in the art can correctly set the distance between an end face of an actuator and an end face of a nozzle surrounding the inflow opening. For example, in a first series of tests, he can close all nozzles except for the nozzle to be tested and, when there is a preselected overpressure in the gas overpressure reservoir, he can measure the amount of liquid fluid flowing out of the nozzle to be tested for a defined time using a precision balance. He can then calculate the volume flow of liquid fluid through this nozzle. He can proceed in the same way with the remaining nozzles and calculate their respective volume flows. On the basis of the volume flow values obtained for the respective nozzles he can either calculate or experimentally determine the required change in the distance between the end face of the actuator and the end face of the nozzle surrounding the inflow opening for each nozzle.

Furthermore, it is possible that the respective actuators having the end face lying in the fluid supply channel, in cooperation with the nozzles assigned to them, are also designed to close the nozzles, wherein at least temporarily, preferably the entire time, during the transport of the at least one printing medium through the effective range of the effective row length of the coating head arrangement in step d), that nozzle or those nozzles is or are closed, preferably automatically, in a fluid-tight manner to which the at least one printing medium is not exposed during its transport through the effective range of the effective row length of the coating head arrangement. This is done by moving the end faces of the respective actuators towards the nozzles assigned to them and arranging them in a fluid-tight manner.

This further development offers the advantage that the dispensing width of the fluid can be precisely matched to the width of the printing medium to be coated so that the amount of fluid that should not be applied to the printing medium is further reduced.

A liquid composition or a suspension which is preferably a non-Newtonian fluid can be used as a liquid fluid.

Furthermore, it is possible that the nozzles of the at least one coating head, preferably of all coating heads, are provided as micronozzles.

In the context of the present description, a micronozzle is understood to mean a nozzle comprising a nozzle channel which is defined by a lateral surface and two base areas, wherein the length of the lateral surface is longer than the width of the respective base area, and wherein the width of the respective base area is ≥15 μm and ≤1000 μm, preferably ≥50 μm and ≤500 μm, particularly preferably ≥80 μm and ≤500 μm, very particularly preferably ≥200 μm and ≤400 μm, and wherein a base area forms the inflow opening to the nozzle channel and the base area opposite the inflow opening forms the outflow opening of the nozzle channel.

According to a very preferred embodiment of the method, in step d), at least in the area of each of the inflow openings of the nozzles, in particular the micro-nozzles, the liquid fluid is subjected to a respective overpressure relative to the atmospheric pressure, which is in a range between 10 mbar and 1500 mbar, preferably in a range between 200 mbar and 400 mbar, above the atmospheric pressure so that an output volume flow of the fluid from the respective nozzle channels is preferably achieved in a range between 5 μl/sec and 100 μl/sec in each case.

This further development has the advantage that the liquid fluid is applied in the required overpressure window in the form of continuous columnar fluid jets without being unfavorably influenced by the air swirled in the transport direction of the at least one transported printing medium.

According to another preferred embodiment, a plurality of printing media are transported along the transport direction, with at least some of the printing media being transported in the transport direction at a distance from at least one of their closest neighbours to be coated, whereby gaps arise in the transport direction between these spaced adjacent printing media, wherein the respective gaps in the transport direction can be divided fictitiously into a central region and a leading and a lagging edge region, and wherein in step d) the liquid fluid is subjected to a respective overpressure relative to the atmospheric pressure at least in the area of each inflow opening of the nozzles before, and preferably also after the time intervals in which the respective printing media are to be coated, in such a way that liquid fluid is dispensed in the form of continuous columnar fluid jets from the nozzles also, but exclusively into predetermined fictitious leading edge regions and/or also, but exclusively into predetermined fictitious lagging edge regions of the respective gaps.

This further development has the advantage that a highly homogeneous application of the liquid fluid is made possible even in the respective lagging edge regions of the respective printing media and/or also in the respective leading edge regions of the respective printing media.

Furthermore, it is possible that during the transport of the printing media in the transport direction a negative pressure is applied to the liquid fluid according to step e) only in the fictitious central area, and preferably only in the leading edge regions and/or only in the fictitious lagging edge regions of the respective gaps.

It is self-explanatory that when the method according to the invention is at a standstill, in particular when the printing media are not transported, the liquid fluid is generally subjected to a negative pressure in accordance with step e) in order to prevent it from flowing out of the nozzle channels even without or without the participation of the respective closing bodies assigned to the nozzles. An exception to this is when an outflow is desired for cleaning purposes at least of the at least one coating head.

According to a further preferred embodiment of the method according to the invention, the liquid fluid dispensed from the nozzles in step d) and not applied to the at least one printing medium is preferably collected by means of a collecting device and disposed of.

As a result, fluid that is not applied to the at least one printing medium is not fed back to the fluid supply channel so that the risk of contamination, for example due to dusty air, and/or a change in concentration, for example due to evaporation of volatile components of the fluid into the atmosphere, is excluded. It is known from the ceramics industry that glaze or engobe or smaltobe suspensions that are exposed to the atmosphere for a longer period of time but are still used for coating usually result in coatings of a different color after the coating had been fired on the printing medium.

According to a particularly preferred embodiment of the method, several printing media are transported along the transport direction, with at least some of the printing media being transported in the transport direction at a distance from at least one of their closest neighbors to be coated, whereby gaps arise in the transport direction between these spaced adjacent printing media, wherein, in step d) the liquid fluid is subjected to a respective overpressure relative to the atmospheric pressure at least in the area of each inflow opening of the nozzles, in such a way that the coating head activates continuous columnar fluid jets in a synchronized manner exclusively in the area of the printing medium, so that the liquid fluid in the form of continuous columnar fluid jets is exclusively dispensed from the nozzles in the area of the respective printing media.

Furthermore, it is possible that the coating head is arranged in a stationary manner and at least during step d), and preferably also during step e), the transport of the at least one printing medium along the transport direction takes place uniformly at a speed greater than zero.

Furthermore, it is possible that the coating head is arranged in a stationary manner and at least during step d), and preferably also during step e), the transport of the at least one printing medium along the transport direction takes place uniformly at an adjustable speed greater than zero, wherein the desired speed was selected from several available speeds.

This further development has the advantage that the amount of liquid fluid that is applied to the printing medium can be adjusted per area and unit of time, and in particular can be increased, even if the flow rate of liquid fluid per nozzle, for a given number of nozzles, represents a limiting factor.

The method can be used to coat several ceramic printing media with a glaze or engobe or smaltobe as a liquid fluid, each in the form of a suspension, by applying it to the respective ceramic printing media and then at least partially concentrating it.

The term “concentrating” is understood to mean the absorption of the liquid fluid by at least a layer in contact with it, in particular a particle layer, and/or the removal of at least one volatile component of the liquid fluid by evaporation and/or vaporization, i.e. by drying.

Concentrating and/or hardening the coating is advantageous because this allows a further layer to be applied to the concentrated and/or hardened coating without the materials of the two layers mixing before the firing process and thus resulting in blurred images, if the layer applied to the coating is a colored image.

The engobe suspension is a thin clay mineral mass. This can be slurry.

In the present description, a suspension of “smaltobe” is understood to mean a mixture of a glaze suspension and an engobe suspension.

The object of the present invention is also achieved in particular by a method for producing relief-like decors on ceramic printing media.

The method according to the invention for producing relief-like decors on ceramic printing media includes the steps:
f) transporting a plurality of ceramic printing media along a transport direction;
g) dispensing drops of a first glaze suspension which comprises at least a frit-containing glaze material in the form of particles, with a plurality of nozzles of an inkjet printer onto a partial area of the respective printing media and concentrating the drops applied to the respective partial area such that at least partially concentrated glaze material forms projections, leading to the formation of a relief-like decor, wherein a continuous unidirectional relative movement takes place between the nozzles of the inkjet printer and the printing media during the ejection of the drops;
h) firing the ceramic printing media to create fired relief-like decors on the printing media.

According to the invention, after step g) and before step h), an opaque glaze or engobe or smaltobe, each in the form of a suspension, is applied as a liquid fluid to the entire surface of the relief-like decors of the respective printing media using a method according to the invention for coating the printing media and is concentrated.

In a preferred embodiment of the method according to the invention for producing relief-like decors on ceramic printing media, before step (g), a priming glaze or engobe or smaltobe, each in the form of a suspension, is applied to the entire surface of the respective ceramic printing media using a method according to the invention for coating the ceramic printing media and is concentrated.

Furthermore, it is possible that at least one coating head is provided in which no side wall of the fluid supply channel is made in one piece together with the respective nozzles and the end face of the respective nozzles surrounding the inflow opening is flush with an inner surface of a side wall of the fluid supply channel that is in contact with the fluid.

Furthermore, it is possible that after the formation of the covering glaze layer a predetermined single-color or multicolored motif is applied to the surface of the covering glaze layer using an application device which is preferably an inkjet printer.

This further development is advantageous because it allows color uniformity to be achieved on areas of the surface printed with the same color after firing. In contrast, when parts of the first glaze layer formed by projections and parts of the surface that are not covered with the first glaze layer are printed with the same color, this usually results in different colors forming after firing.

According to a further preferred embodiment of the method, a protective layer comprising a frit which is or becomes transparent after firing is applied to the applied image.

The protective layer can be formed from a composition which is suitable for increasing the mechanical resistance of the motif to abrasion and/or for increasing the chemical resistance to acids and alkalis. The relevant materials are known to those skilled in the art.

Furthermore, it is possible that the nozzles of the at least one coating head are made of ceramic, hard metal or surface-treated steel and/or the end face of the respective actuators are made at least in sections of ceramic, hard metal or surface-treated steel.

It is thus possible to increase the service life of the nozzles when abrasive liquid fluids such as a glaze or engobe or smaltobe suspension are used.

Alternatively, it is possible that the nozzles arranged on the side wall or on a part of the side wall of the coating head and the side wall or the part of the side wall itself are each made of ceramic, hard metal or surface-treated steel, wherein preferably those nozzles arranged on the side wall or on the part of the side wall of the coating head and the side wall or the part of the side wall are provided together in one piece.

The method can be used for coating a printing medium, in particular a textile web, by preferably using a primer as the fluid, preferably without solid particles, and transporting one printing medium instead of several printing media along a transport direction in step c).

The method can also be used for coating a textile web as a printing medium with a suitable liquid fluid to form a primer layer or a layer absorbing the ink on the textile web.

The invention is explained in more detail below with reference to the attached drawings using a particularly preferred embodiment.

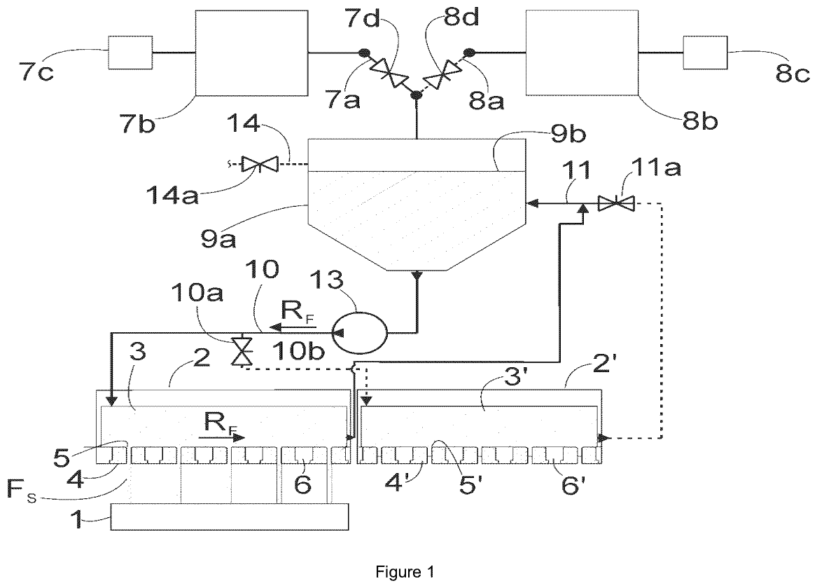

FIG. 1A shows a specific instant of time in process step d) of a particularly preferred embodiment of the method according to the invention in which a particularly preferred coating head arrangement was provided.

FIG. 1B shows the process step e) of the particularly preferred embodiment of the method according to the invention in which the particularly preferred coating head arrangement from FIG. 1A was provided.

For the sake of order, it should be noted that for a better understanding of the structure of the fluid circuit system, its components have been represented out of scale and/or enlarged and/or reduced in size and schematically.

FIG. 1A shows a specific instant of time in process step d) of a particularly preferred embodiment of a method according to the invention. In this particularly preferred embodiment, several printing media 1 are transported along a transport direction, with at least some of the printing media 1 being transported in the transport direction at a distance from at least one of their closest neighbours to be coated. The transport direction of the printing media 1 is the direction that goes into the image plane (and is therefore not visible in FIG. 1A). This creates gaps in the transport direction between these spaced adjacent printing media 1, wherein the respective gaps in the transport direction can be divided fictitiously into a central region and a leading and a lagging edge region.

As shown in FIG. 1A, a fluid circuit system comprising the two coating heads 2, 2′ was provided in the particularly preferred embodiment of the method according to the invention for supplying two coating heads 2, 2′ with liquid fluid. Each of the two coating heads 2, 2′ comprises a fluid supply channel 3, 3′, a plurality of nozzles 4, 4′, each with a nozzle channel and an inflow opening 5, 5′ which form the connection of the respective nozzle channels to the respective fluid supply channel 3, 3′. The respective nozzles 4, 4′ are arranged in a stationary manner on a side wall 6, 6′ of the respective fluid supply channel 3, 3′. For the sake of clarity, the reference numbers in FIGS. 1A and 1B have only been included for one nozzle 4, 4′ of the nozzles shown. The liquid fluid is shown in dashed lines in the two fluid supply channels 3, 3′.

Each of the coating heads 2, 2′ of a coating head arrangement has a row of nozzles aligned at an angle of 90° to the transport direction of the printing medium 1 and the coating head arrangement has an effective row length. The effective row length corresponds to the total length of the effective area of the coating head arrangement transversely to the transport direction of the printing medium 1 and corresponds in the present case to the sum of the two effective areas of the coating heads 2, 2′. The coating heads 2, 2′ can be fluidically connected parallel to one another with the supply line 10 and a return line 11 of the fluid circuit, wherein the coating head 2′ can be separated fluidically from the fluid circuit system and, as shown in FIGS. 1A and 1B, has been separated in the present method from the supply line 10 and from the return line 11 of the fluid circuit system both in step d) and in step e).

Like the other printing media 1 (not shown), the printing medium 1 each has a width that is smaller than the effective row length of the coating head arrangement and is only transported into the effective area of the coating head 2 during step d) so that the respective printing media 1 should only be coated with the coating head 2.

Therefore, even during the transport of the respective printing media 1 through the effective range of the effective row length of the coating head arrangement in step d), the coating head 2′ is fluidically separated from the fluid circuit system to which the respective printing media 1 are not exposed by automatically blocking both the valve 10a and the valve 11a. The valve 10a is provided upstream in the supply line 10 with respect to the coating head 2′ and the valve 11a is provided downstream in the return line 11 with respect to the coating head 2.

In step d), the liquid fluid is subjected to a respective overpressure relative to the atmospheric pressure, at least in the area of each inflow opening 5 of the nozzles 4, at least during the time intervals in which the at least one printing medium 1 is to be coated, in such a way that the liquid fluid is applied in in the form of continuous columnar fluid jets F_{S} onto the printing medium 1 (see FIG. 1A). For the sake of clarity, the reference numerals have only been included in FIG. 1A for one continuous columnar fluid jet F_{S}.

In this method, the liquid fluid is subjected to a respective overpressure relative to the atmospheric pressure, at least in the area of each inflow opening of the nozzles 4, before and after the time intervals in which the respective printing media 1 are to be coated, in such a way that liquid fluid in the form of continuous columnar fluid jets is also, but exclusively dispensed from the nozzles 4 into predetermined fictitious leading edge regions and/or also, but exclusively into predetermined fictitious lagging edge regions of the respective gaps.

As further shown in FIG. 1A, the fluid circuit system was provided with a fluid path that fluidically connects a fluid tank 9a to the coating head 2, wherein the fluid path fluidically connects the coating heads 2, 2′ between the supply line 10 and the return line 11, which are each connected to the fluid tank 9a, so that due to the blocked valves 10a and 10b, liquid fluid is permanently pumped only from the fluid tank 9a via the supply line 10 through the coating head 2 and via the return line 11 back to the fluid tank 9a.

The fluid supply channels 2, 2′ were filled before the valves 10a and 11a were closed for step d) by filling the fluid tank 9a with liquid fluid in such a way that a free liquid fluid surface 9b was formed in the fluid tank 9a with respect to a gaseous fluid.

During operation, the fluid circuit system objectively forms a fluid circuit that is closed outwards to the atmosphere except for the nozzles 4 of the coating head 2 and through which liquid fluid is permanently pumped in a flow direction R_{F} (see supply line 10 and fluid supply channel 3) using a centrifugal pump 13.

During step d), the liquid fluid is subjected to overpressure using a gas overpressure reservoir 8b of a first means for applying an overpressure to the liquid fluid, while the overpressure prevailing in the gas overpressure reservoir 8b relative to the atmospheric pressure is controlled with a compressor 8c of the first means. In step d), a second operative fluid connection 7a between the fluid tank 9a and a gas negative pressure reservoir 7b of the second means is kept closed by a valve 7d keeping the second operative fluid connection 7b blocked, while a first operative fluid connection 8a between the fluid tank 9a and the gas overpressure reservoir 8b of the first means is kept open by a valve 8d keeping the first operative fluid connection 8a open. The second operative fluid connection 7a is shown schematically in dashed lines in its closed state in FIG. 1A.

A transition from step d) to step e) takes place during the transition from the leading edge region of the respective gap to the fictitious central region of the respective gap between the respective printing medium 1 and its neighbour by closing the first operative fluid connection 8a between the fluid supply channel 3 and the gas overpressure reservoir 8b of the first means and by opening the second operative fluid connection 7a between the fluid supply channel 3 and the gas negative pressure reservoir 7b of the second means and by keeping the second operative fluid connection 7a open during step e) and the first operative fluid connection 8a closed.

As shown in FIG. 1B, in method step e), the liquid fluid is subjected to a respective negative pressure relative to the atmospheric pressure at least in the area of each inflow opening 5 of the nozzles 4 during the time intervals in which no liquid fluid is to be dispensed from the nozzles 4, wherein an outflow of liquid fluid from the nozzle channels is prevented in step e) even without the participation of the closing bodies assigned to the nozzles 4. As further shown in FIG. 1B, the liquid fluid forms a meniscus 5b in the nozzle channels of the nozzles 4 during step e).

In step e), a second operative fluid connection 7a between the fluid tank 9a and a gas negative pressure reservoir 7b of the second means is kept open by a valve 7d keeping the second operative fluid connection open, while the first operative fluid connection 8a between the fluid tank 9a and the gas overpressure reservoir 8b of the first means is kept closed by a valve 8d keeping the first operative fluid connection 8a blocked. The first operative fluid connection 8a is shown schematically in dashed lines in its closed state in FIG. 1B.

A transition from step e) to step d) takes place during the transition from the fictitious central region of the respective gap to the fictitious lagging edge region of the respective gap between the respective printing medium 1 and its neighbour by opening the first operative fluid connection 8a between the fluid tank 9a and the overpressure reservoir 8a of the first means and closing the second operative fluid connection 7a between the fluid tank 9a and the gas negative pressure reservoir 7a of the second means.

Steps d) and e) as well as the transitions between steps d) to e) and e) to d) are carried out repeatedly as mentioned above to coat the subsequent printing media 1.

As soon as the liquid fluid in the fluid tank 9a falls below a certain volume, the fluid tank 9a is filled with liquid fluid by coupling an external fluid canister to the fluid line 14 and opening the valve 14c to allow liquid fluid to flow into the fluid tank 9a until the fluid tank 9a was filled with the desired amount of liquid fluid. It is self-explanatory that even when filling the fluid tank, the liquid fluid is subjected to a respective negative pressure relative to the atmospheric pressure, at least in the area of each inflow opening 5 of the nozzles 4, thereby preventing the liquid fluid from flowing out of the nozzle channels even without the participation of the closing bodies assigned to the nozzles 4 in step e).

1. A method for coating at least one printing medium, comprising the steps of:
a) providing at least one coating head with a fluid supply channel, a plurality of nozzles, each having a nozzle channel and an inflow opening, which form the connection of the respective nozzle channels to the fluid supply channel, wherein the respective nozzles are arranged in a stationary manner on a side wall of the fluid supply channel;
b) filling the fluid supply channel with liquid fluid;
c) transporting the at least one printing medium along a transport direction;
d) applying a respective overpressure relative to the atmospheric pressure to the liquid fluid, at least in the area of each inflow opening of the nozzles, at least during the time intervals in which the at least one printing medium is to be coated in such a way that the liquid fluid is applied in the form of continuous columnar fluid jets Fₛ to the at least one printing medium, and
e) during the time intervals in which no liquid fluid is to be dispensed from the nozzles, a respective negative pressure relative to the atmospheric pressure is applied to the liquid fluid at least in the area of each inflow opening of the nozzles, as a result of which an outflow of liquid fluid from the nozzle channels, even without the participation of the respective closing bodies assigned to the nozzles, is prevented in step e) and made possible in step d).

2. The method according to claim 1, further comprising a fluid circuit system provided for supplying the at least one coating head with liquid fluid, comprising the at least one coating head, which system forms a fluid circuit during operation that is closed outwards to the atmosphere except for the nozzles of the at least one coating head and through which liquid fluid is pumped in a flow direction (R_{F}).

3. The method according to claim 1,
wherein overpressure is applied to the liquid fluid using a first means for applying the overpressure to the liquid fluid and the negative pressure is applied to the liquid fluid using a second means for applying the negative pressure to the liquid fluid, wherein a transition from step e) to step d) takes place by opening a first operative fluid connection between the fluid supply channel and the first means and closing a second operative fluid connection (8a) between the fluid supply channel and the second means, and during step d) the first operative fluid connection remains open and the second operative fluid connection remains closed, wherein a transition from step d) to step e) takes place by closing the first operative fluid connection between the fluid supply channel and the first means and opening the second operative fluid connection between the fluid supply channel and the second means and during step e) the first operative fluid connection remains closed and the second operative fluid connection remains open.

4. The method according to claim 3, wherein the overpressure is applied to the liquid fluid using a gas overpressure reservoir of the first means, while the overpressure prevailing in the gas overpressure reservoir relative to the atmospheric pressure is controlled by means of a compressor of the first means and wherein the negative pressure is applied to the liquid fluid using a gas negative pressure reservoir (7b) of the second means, while the negative pressure prevailing in the gas negative pressure reservoir (7c) relative to the atmospheric pressure is controlled by means of a vacuum pump (7c) of the second means.

5. The method according to claim 4, wherein a respective overpressure relative to the atmospheric pressure is applied to the liquid fluid in the area of each inflow opening of the nozzles, such that in step d) per unit of time between 1/50 and ½ of the volume of liquid fluid pumped through the fluid supply channel (3) is dispensed through the nozzles, wherein the cross-sectional area of the fluid supply channel of the at least one coating head.

6. The method according to claim 3, further comprising the steps of:
providing the fluid circuit system with a fluid path that fluidically connects a fluid tank to the at least one coating head, wherein the fluid path fluidically connects the at least one coating head between a supply line and a return line, each of which is coupled to the fluid tank so that liquid fluid is pumped from the fluid tank via the supply line through the coating head and back to the fluid tank via the return line,
wherein the filling of the fluid supply channel is carried out by filling the fluid tank with liquid fluid in such a way that a free liquid fluid surface is formed in the fluid tank with respect to a gaseous fluid, which fluid surface is subjected to overpressure in step d) and accordingly to negative pressure in step e),
wherein the fluid tank is provided with a sufficiently large capacity for the liquid fluid and with a free liquid fluid surface in a ratio of ≥10:1 to the cross-sectional area of the fluid supply channel.

7. The method according to claim 1, wherein the coating of liquid fluid applied to the at least one printing medium is concentrated and/or hardened.

8. The method according to claim 3, wherein the coating head arrangement is provided with a plurality of coating heads, each coating head having at least one row of nozzles aligned at a certain angle to the transport direction of the at least one printing medium and the coating head arrangement having an effective row length, and wherein the coating head arrangement is designed such that the coating heads can be fluidically connected to the fluid path, in particular to the supply and return line, parallel to one another and/or in series to one another, and at least one coating head can be fluidically separated from the fluid circuit system, wherein, at least temporarily during the transport of the at least one printing medium through the effective range of the effective row length of the coating head arrangement in step d), at least that coating head of the plurality of coating heads is fluidically separated from the fluid circuit system, in particular from the supply and return line, to which the at least one printing medium is not exposed.

9. The method according to claim 2, further comprising an actuator with an end face lying in the fluid supply channel is respectively assigned to at least some nozzles of the at least one coating head for the respective regulation of the flow rate of the liquid fluid between the end face of the actuator and an end face of the nozzle surrounding the inflow opening, wherein, while the liquid fluid is being pumped from an inflow opening to an outflow opening of the fluid supply channel, a pressure drop of the liquid fluid along the fluid supply channel in the flow direction R_{F} of the liquid fluid at the respective inflow openings of the nozzles is partially compensated for with respect to a selected nozzle by adjusting the respective distance between the respective end faces of the actuators and the respective end faces of the nozzles surrounding the inflow opening by reducing or increasing the corresponding distance by moving the end face of the respective actuators towards the nozzle.

10. The method according to claim 9, wherein the respective actuators having the end face lying in the fluid supply channel, in cooperation with the nozzles assigned to them, are also designed to close the nozzles, wherein at least temporarily during the transport of the at least one printing medium through the effective range of the effective row length of the coating head arrangement in step d), that nozzle or those nozzles is or are closed in a fluid-tight manner to which the at least one printing medium is not exposed during its transport through the effective range of the effective row length of the coating head arrangement by moving the end faces of the respective actuators towards the nozzles assigned to them and arranging them in a fluid-tight manner.

11. The method according to claim 1, wherein a liquid composition or a suspension is used as a liquid fluid.

12. The method according to claim 1, wherein the nozzles of the at least one coating head are provided as micronozzles.

13. The method according to claim 1, wherein a plurality of printing media are transported along the transport direction, wherein at least some of the printing media are transported in the transport direction at a distance from at least one of their closest neighbours to be coated, whereby gaps arise in the transport direction between these spaced adjacent printing media, wherein the respective gaps in the transport direction can be divided fictitiously into a central region and a leading and a lagging edge region, and wherein in step d) the liquid fluid is subjected to a respective overpressure relative to the atmospheric pressure at least in the area of each inflow opening of the nozzles before, and after the time intervals in which the respective printing media are to be coated, in such a way that liquid fluid is dispensed in the form of continuous columnar fluid jets from the nozzles also, but exclusively into predetermined fictitious leading edge regions and/or also, but exclusively into predetermined fictitious lagging edge regions of the respective gaps.

14. The method according to claim 13, wherein during the transport of the printing media in the transport direction, the liquid fluid is subjected to negative pressure according to step e) only in the fictitious central area.

15. The method according to claim 1, wherein the liquid fluid dispensed from the nozzles in step d) and not applied to the at least one printing medium.

16. The method according to claim 1, wherein the coating head is arranged in a stationary manner and at least during step d), the transport of the at least one printing medium along the transport direction takes place uniformly at a speed greater than zero.

17. The method according to claim 16, wherein at least during step d), the transport of the at least one printing medium along the transport direction takes place uniformly at an adjustable speed greater than zero, wherein the desired speed has been selected from several available speeds.

18. An application of a method according to claim 1 for coating a plurality of ceramic printing media with a glaze or engobe or smaltobe as a liquid fluid, each in the form of a suspension, by applying it to the respective ceramic printing media and then at least partially concentrating it.

19. The method of claim 1 further comprising the steps of:
f) transporting a plurality of ceramic printing media along a transport direction;
g) dispensing drops of a first glaze suspension which comprises at least a frit-containing glaze material in the form of particles, with a plurality of nozzles of an inkjet printer onto a partial area of the respective printing media and concentrating the drops applied to the respective partial area, such that at least partially concentrated glaze material forms projections, leading to the formation of a relief-like decor, wherein a continuous unidirectional relative movement takes place between the nozzles of the inkjet printer and the printing media during the ejection of the drops;
h) firing the ceramic printing media to create fired relief-like decors on the printing media,
wherein after step g) and before step h), a covering glaze or engobe or smaltobe, each in the form of a suspension, is applied as a liquid fluid to the entire surface of the relief-like decors of the respective printing media.

20. The method according to claim 19, wherein before step (g) a priming glaze or engobe or smaltobe, each in the form of a suspension, is applied to the entire surface of the respective ceramic printing media according to a method according to claim 18 and is concentrated.

21. An application of the method according to claim 1 for coating a textile web as a printing medium with a suitable liquid fluid to form a primer layer or a layer absorbing the ink on the textile web.
